(19) United States
(12) Patent Application Publication
(10) Pub. No.: US 2008/0003424 A1
(43) Pub. Date: Jan. 3, 2008

(54) Particle Laminated Substate and Method for Manufacturing the Same

(75) Inventor: Koichi Kawamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/666,662

(22) PCT Filed: Nov. 2, 2005
(86) PCT No.: PCT/JP05/20485

§ 371 Date: May 1, 2007

(30) Foreign Application Priority Data
Nov. 2, 2004 (JP) 2004-319288

(51) Int. Cl. B05D 7/00; B32B 5/00

(52) U.S. Cl. 428/327; 427/393.5

(57) ABSTRACT

A particle laminated substrate and a method for manufacturing the particle laminated substrate are disclosed. The particle laminated substrate has a particle accumulation layer formed by accumulating and allowing particles to adhere onto a substrate having a surface where a graft polymer chain is present in which either terminal of the polymer is bonded to the surface of the substrate, by means of an electrostatic accumulating phenomenon, such that a particle density in the vicinity of the surface of the particle accumulation layer is higher than a particle density in the vicinity of the substrate.

### TECHNICAL FIELD

The invention relates to a particle laminated substrate having a particle accumulation layer in which particles, particularly nanoscale diameter particles, accumulate and adhere such that the particles are distributed unevenly so as to have a concentration gradient in the particle accumulation layer with a high density in the vicinity of a surface and a low density in the deep portion of the particle accumulation layer, and a method for manufacturing the same. Specifically, the invention relates to a substrate having a multilayer particle accumulation layer which is novel and useful as a functional material in a wide range of industrial fields such as electroconductive films, optical films, biosensors, gas barrier films and the like, and a method for manufacturing the same.

### BACKGROUND ART

Various approaches for developing useful functional materials wherein a particle layer is formed on a substrate and the functions of the particle are effectively used are being attempted in a variety of fields relating to various optical materials such as highly functional catalysts, highly functional sensors, highly functional transducers, interference thin films, antireflection films, and modulated light films; and various electronic materials such as electroconductive films, electromagnetic shielding films, LSI substrates, semiconductor laser solid-state devices, optical recording media, and magnetic recording media.

Especially, in recent years, attention is being given to research in materials nanotechnology in fundamental technology over a wide range of fields such as information, environment, safety, and energy as an innovative technology. Particularly, a technology for forming a particle layer on a variety of substrates by accumulating/laminating nanoscale particles on the surface of the substrates is noticed as a novel material technology applicable to a wide range of industrial fields such as those for electroconductive films, optical films, biosensors, and gas barrier films (for example, Shipway, A. N. et al., ChemPhysChem, vol. 1 (2000), p. 18, and Templeton, A. C. et al., Acc. Chem. Res., vol. 33 (2000), p 27). These studies point out that in practical use, it is very important to develop a one-step process by which film formation is continuously carried out by accumulating/arranging/depositing manufactured nanoparticles on a substrate, as well as to establish a stable manufacturing method for nanoparticles to sufficiently control size distribution, chemical composition and the like of particles. Heretofore, a method for laminating particles in a multistep process (layer-by-layer=LBL method) has been known as a technology for accumulating/arranging/depositing nanoparticles on a surface to immobilize them (for example, Brust, M. et al., Langmuir, vol. 14 (1998), p. 5425). When this method is applied, it becomes possible to form a particle layer having a regular multilayer structure. However, the method involves complicated steps such as allowing the adsorption of particles, then, covering them with a resin, and further allowing adsorption of the particles but this procedure is unsuitable as a practical method for forming film from particles.

Recently, there is a report for a method of accumulating gold nanoparticles in one-step using a polymer brush wherein polymer terminals are immobilized on the surface of a substrate (for example, Genzer, J. et al., Nanotechnology, vol. 14 (2003), p. 1145). In this method, a polyacrylamide brush formed on a glass surface is immersed overnight in a low pH dispersion of gold nanoparticles having negative charge, whereby a film wherein the nanoparticles are three-dimensionally accumulated due to an electrostatic mutual action between amide group (—NH₃⁺) charged positively in the dispersion and the nanoparticle having negative charge is formed. Furthermore, the present inventor and others have also proposed a surface functional material prepared by allowing a variety of functional particles to adhere to a surface on which polyacrylic acid is grafted (for example, see Japanese Patent Application Laid-Open (JP-A) No. 2003-112379). According to these methods, a particle layer can be formed on the surface of an arbitrary substrate in a simple manner. However, an internal structure such as particle distribution in the particle layer is unknown. Accordingly, an orientation of particles, particularly that of nanoparticles, cannot be controlled in the particle accumulation layer. Under these circumstances, improvements in a particle accumulation layer are desired for improving surface functionalities.

### DISCLOSURE OF INVENTION

The invention has been made in view of the situation as described above. The invention provides a particle laminated substrate having a high-quality particle accumulation layer formed on a substrate wherein functional particles are distributed unevenly so as to have a concentration gradient in the particle accumulation layer with a high density in the vicinity of a surface and a low density in the deep portion of the particle accumulation layer. Furthermore, the invention provides a novel method for manufacturing a particle laminated substrate by which the particle laminated substrate wherein functional particles distributed in a high density in the vicinity of a surface of a particle accumulation layer can be easily formed by simple steps through controlling a method for accumulating particles.

The present inventor, having studied the characteristic properties of a substrate having a graft polymer on a surface thereof, and as a result, found that the above-described particle laminated substrate and method for manufacturing the same can be achieved by using a substrate having a graft polymer chain on the surface thereof to complete the invention.

A first aspect of the invention provides a particle laminated substrate comprising a particle accumulation layer formed by accumulating and allowing particles to adhere onto a substrate having a surface where a graft polymer chain is present wherein either terminal of the polymer is bonded to the surface of the substrate, by means of an electrostatic accumulating phenomenon, wherein a particle density in the vicinity of the surface of the particle accumulation layer is higher than a particle density in the vicinity of the substrate.

A method for manufacturing a particle laminated substrate, comprising: allowing a surface of the substrate where a graft polymer chain, which has a functional group which is chargeable positively or negatively and whose either terminal is bonded to the surface of the substrate, is present to be in contact with a liquid containing particles each of which have a surface charged to a charge inverse to that of the charged functional group, thereby causing the graft polymer to swell and expand in the liquid; allowing the particles whose surfaces are charged to a charge inverse to that of the functional group to adhere to the functional group of the graft polymer charged positively or negatively in the liquid by means of an electrostatic accumulating phenomenon; and thereafter, removing the liquid and drying to form a particle accumulation layer, wherein a particle density in the vicinity of the surface of the particle accumulation layer is higher than a particle density in the vicinity of the substrate.

The term “particle accumulation layer” in the invention means a layer formed by allowing particles to adhere to graft polymer chains. Thus, a thickness of the particle accumulation layer corresponds to that of a whole layer containing the graft polymer chains distributed on a surface of a substrate and the particles adhered thereto.

### BRIEF DESCRIPTION OF DRAWINGS

FIG. 1 is a model diagram illustrating a condition wherein particles adhere to a graft polymer to form a particle accumulation layer;

FIG. 2 is an absorption spectrum of a particle laminated substrate obtained by accumulating and allowing gold particles to adhere to polyacrylic acid grafts;

FIG. 3 is a graph indicating a relationship between a film thickness of a particle accumulation layer measured directly by means of ellipsometry and an immersion time of a substrate in a particle dispersion;

FIG. 4 is a sectional TEM photograph showing a particle laminated substrate obtained in example 1 wherein gold particles adhere to a surface of the substrate;

FIG. 5A is a graph indicating measured results of glow discharge spectrometry (GDS) of a substrate having a surface where graft polymers to which particles have not yet adhered are present, FIG. 5B is a graph indicating measured results of glow discharge spectrometry (GDS) of a substrate having a particle accumulation layer formed by immersing the substrate into a gold particle dispersion for five minutes, and FIG. 5C is a graph indicating measured results of glow discharge spectrometry (GDS) of a substrate having a particle accumulation layer formed by immersing the substrate into a gold particle dispersion for thirty minutes; and

FIGS. 6A and 6B are graphs each indicating distributions in volume ratio of particles in its depth direction of a particle accumulation layer determined from a sputtering time in GDS method, an elemental ratio of constituent atoms in the particle accumulation layer, and specific gravities of respective materials; wherein FIG. 6A is a graph indicating distributions in volume ratio of particles in the direction of depth of the particle accumulation layer formed by immersing a substrate into a gold particle dispersion for five minutes; and FIG. 6B is a graph indicating distributions in volume ratio of particles in the direction of depth of the particle accumulation layer formed by immersing a substrate into a gold particle dispersion for thirty minutes.

### BEST MODE FOR CARRYING OUT THE INVENTION

In the following, the present invention will be described in detail.

A particle laminated substrate of the present invention is characterized by having a particle accumulation layer formed by allowing particles to adhere onto the substrate having a surface where a graft polymer chain is present, so that the particles distribute unevenly so as to have a high density in the vicinity of the surface, that is, to distribute at a high density in the surface while at a low density in the deep portion or, in other words, on the side of a boundary face of the substrate. Because of such a particle accumulation layer, functions of functional particles which adhered to a surface of the substrate are effectively developed, whereby a functional material applicable to a variety of fields in response to functions of the particles can be provided.

The particle accumulation layer in the invention is obtained by accumulating and allowing particles to adhere to a graft polymer of which either terminal is bonded to a surface of the substrate due to an electrostatic accumulating phenomenon, and is characterized in that particle density in the vicinity of the surface is higher than that in the vicinity of the substrate.

An average thickness of the particle accumulation layer measured by means of a sectional TEM photograph is preferably 10 nm to 2000 nm, and in this range, excellent functions involving the particles are developed more effectively. A more preferable film thickness of the particle accumulation layer is in the range of 20 nm to 1000 nm, and the most preferable range is from 30 nm to 500 nm.

Although the region where particles are adsorbed (particle adsorption region) may be controlled by means of a contact time with a particle dispersion, it is usually about 10 to 90% in the vicinity of a surface with respect to a film thickness of the particle accumulation layer. Inside the particle adsorption region, particles exists at a high density in the vicinity of the surface, and the density decreases in the vicinity of a boundary surface of the substrate. Since particles adhering electrostatically to graft polymers distribute unevenly so as to have a high density in the vicinity of the surface, functions due to the particles are developed more effectively in the surface of the particle accumulation layer relative to the total amount of particles which have adhered.

As for the uneven distribution of particles in the particle accumulation layer, in a particle accumulation layer laminated on a substrate, it is preferred that a particle content in an outermost surface of the particle accumulation layer is 30% by volume or more, while a particle content is 10% by volume or less in a boundary surface on the substrate side being the bottom of the particle accumulation layer. More preferably a particle content in an outermost surface is 40% by volume or more, while a particle content is 5% by volume or less in the boundary surface of the substrate side being the bottom of the particle accumulation layer.

A distribution of particles in a particle accumulation layer may be determined by, for example, measuring abundance ratios of respective elements with UV spectrum on the basis of constituent elements of the particles and graft polymers, or by detecting a distribution of the respective elements inside the layer by the application of glow discharge spectrometry (GDS) which will be described in detail.

In the GDS method, a surface of a sample is sputtered with argon glow to chip off the surface, and fluorescence of elements discharged at that time is detected, whereby compositions of the elements existing on the surface are analyzed. Since sputtering proceeds in the depth direction with elapse of time, an elemental analysis of a film composition in the depth direction can be made.

There are respective methods such as ESCA analysis, Auger analysis, and TOF-SIMS in addition to the GDS method as a manner for analyzing elements or constituent molecules while chipping off the surface of a sample, and any of these methods enumerated is applicable.

As specifically described in examples, it is possible to determine amounts of elements in the depth direction in accordance with the above-described method to extrapolate weights of constituent materials from the amounts of the elements, thereby to determine a volume ratio of each material from specific gravity of the constituent materials.

Next, a method for forming a particle accumulation layer, which is obtained by assembling particles in such a condition wherein a particle density in the vicinity of a surface is higher than that in the vicinity of a substrate, on the substrate will be described.

In the invention, since particles adhered electrostatically to a graft polymer distribute unevenly so as to be at high density in the vicinity of a surface, functions due to the particles are more effectively developed relative to the total amount of particles which have adhered, so that the particle laminated substrate of the invention may be used as an excellent functional material.

First, a substrate having a surface where a graft polymer chain is present is prepared wherein either terminal of the polymer is bonded to a surface of the substrate. The substrate will be described in detail hereinafter. In this case, any substrate may be selected so far as it has the required strength and characteristics depending on the application of the particle laminated substrate of the invention. Examples thereof include general-purpose substrates such as glass substrates, silicon substrates and the like.

For a substrate having a surface where a graft polymer chain is present, a substrate wherein the graft polymer chain is bonded directly to the surface of the substrate may be used, or a substrate having an intermediate layer to which a graft polymer is easily bonded and onto which the graft polymer has been grafted into may be used.

Moreover, the substrates having a surface where a graft polymer chain is present in the invention include: the one prepared by applying or applying/crosslinking to a raw substrate a polymer wherein a graft polymer chain is bonded to a backbone polymer, or a polymer wherein a graft polymer chain is bonded to a backbone polymer, and wherein crosslinkable functional groups are also introduced; and the one prepared by applying or applying/cross-linking a composition containing a polymer having a crosslinkable group at a terminal of the polymer and a crosslinking agent to a raw substrate.

The graft polymer chain which is present on a substrate of the present invention is characterized by having a structure such that either terminal of the polymer is bonded to a surface of the substrate directly or via an intermediate layer formed on a surface of the substrate; and a graft polymer chain part having a functional group capable of adhering to particles as a result of interaction between the functional group and particles, such as a hydrophilic group or a functional group capable of being charged negatively, are not substantially crosslinked. Because of the structure as described above, mobility of a polymer part containing such specified functional groups is not limited, or the polymer part is buried in a firm crosslinked structure, and high mobility can be assured.

A molecular weight Mw of such graft polymer chains is preferably in the range of 500 to 5,000,000, and more preferably in the range of 1,000 to 1,000,000, and the most preferably in the range of 2,000 to 500,000.

Such introduction of graft polymer chains into the surface of a substrate may be made by a well-known method, for example, a surface graft polymerization method. An example of the method includes any of well-known methods described in the following documents such as Shin Kobunshi Jikken-gaku (New Polymer Experimentology) 10, edited by The Society of Polymer Science, Japan, published in 1994 from Kyoritsu Shuppan Co., Ltd.; page 135 wherein optical graft polymerization method, and plasma irradiation graft polymerization method are described as a surface graft polymerization method; Kyuchaku Gijutsu Binran (Handbook of Adsorption Technology), under the editorship of Takeuchi, published in February 1999 from NTS Inc.; pages 203 and 695 wherein radiation irradiation graft polymerization method for γ ray, electron ray or the like is described. As examples of a specific method for optical graft polymerization method, methods described in JP-A Nos. 63-92658, 10-296895, and 11-119413 are applicable. In plasma irradiation graft polymerization method, and radiation irradiation graft polymerization method, the methods described in the above documents, and that described in Y. Ikeda et al., Macromolecules, vol. 19, page 1804 (1986) and the like are applicable.

A crosslinked hydrophilic layer into which graft chains are introduced may be obtained by preparing a graft polymer in accordance with a well-known method as a usual manner for synthesizing a graft polymer, and crosslinking the same. Specifically, a synthesis of a graft polymer is described in Fumio Ide, Graft Polymerization and the Application Therefor, published in 1977 from KOBUNSHI KANKO-KAI (Macromolecule Publish Institute), and Shin Kobunshi Jikken-gaku (New Polymer Experimentology)2, Synthesis-Reaction of Polymer, edited by The Society of Polymer Science, Japan, published in 1995 from Kyoritsu Shuppan Co., Ltd.

In addition thereto, the methods proposed by the present inventor in JP-A Nos. 2003-112379 and JP-A No. 2005-264078, Japanese Patent Application No. 2004-85653 and the like may be applied.

In the following, an example of a manufacturing method of the invention will be described in detail with reference to a method for forming a particle laminated substrate wherein gold particles are allowed to adhere to the surface of the substrate having a polyacrylic acid graft polymer.

[Preparation of Substrate Containing Graft Polymer]

A polyacrylic acid graft with respect to a silicon substrate or a glass substrate is made in such a manner that an initiator fixed on a surface of the substrate is used as a starting point, acrylic acid is allowed to be in contact with the surface thereof, and light exposure is applied thereto. Specifically, first, the initiator is immobilized on the silicon substrate or the glass substrate. Namely, the substrate the surface of which is washed is immersed in 1% by mass of toluene solution of a silane terminal initiator (hereinafter referred to as “SiP”) represented by the following formula at room temperature for 10 minutes, then, the substrate is taken out, and washed sufficiently with toluene to obtain the substrate to which the initiator is immobilized.

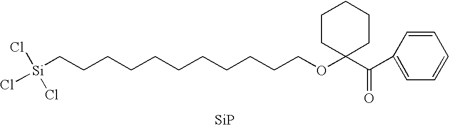

Thereafter, acrylic acid is subjected to photopolymerization to form graft chains. The resulting substrate on which the initiator is immobilized as described above is immersed in an aqueous solution (10% by mass) of acrylic acid, then irradiation is made for 5 minutes using an ultraviolet exposure apparatus (trade name: UVX02516S1LP01, 1.5 kW, manufactured by Ushio Inc.), thereafter, the substrate is taken out to be washed repeatedly with water, and washed further with sodium bicarbonate water (5% by mass) thereby to obtain the substrate to a surface of which acrylic acid is grafted.

[Adhesion of Gold Particles]

(Adjustment of Surface Charge of Gold Particles)

A synthesis of gold nanoparticles protected by a quaternary ammonium protective agent (TMC: a structure is represented by the following formula) is as follows. Tetrachloroauric acid is reduced with sodium boron hydride in the presence of the quaternary ammonium protective agent (TMC) in an aqueous solution. From TEM measurement, it is found that an average particle diameter of the resulting particles is about 5 nm wherein the particles are distributed from a comparatively small particle diameter of about 1 nm to a large particle diameter of about 7 nm. 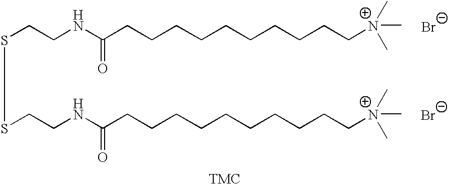
(Adhesion of Gold Particles to Graft Polymer)

Adsorption of gold nanoparticles to the substrate to which polyacrylic acid is grafted as described above is made as follows. First, a polyacrylic acid graft film prepared on a glass or silicon substrate is immersed in an aqueous dispersion of gold nanoparticles (pH=8.9) for a predetermined time. Thereafter, the sample is taken out, and then washed with a sufficient amount of water.

Although the gold particles are described as an example, particles made of the other functional materials which will be described later may be allowed to adhere to a graft polymer in accordance with the same manner.

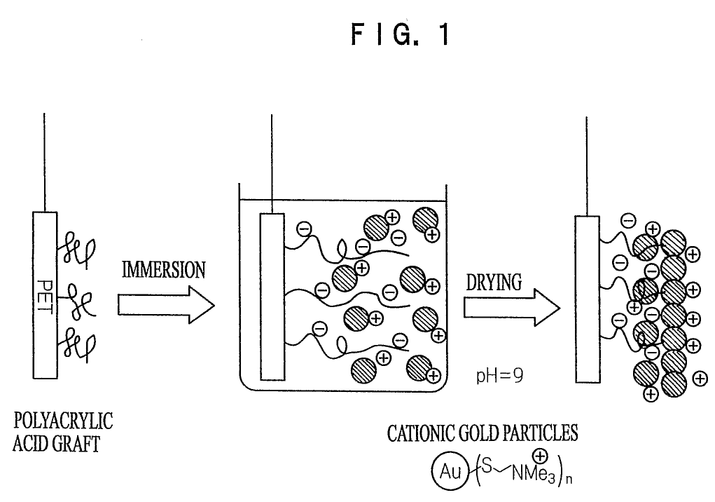

A mechanism for forming a particle accumulation layer wherein the particles are allowed to adhere to functional groups in a graft polymer, and laminated, so that the particles are distributed unevenly is not clear. However, it is presumed as follows. FIG. 1 is a model diagram illustrating a condition wherein particles adhere to a graft polymer to form a particle accumulation layer wherein a solution of the graft polymer introduced on the substrate, i.e. a gold particle dispersion into which the acrylic acid graft substrate is immersed in this case has a pH of 8.9. In this condition, it may be considered that the acrylic acid graft is in a substantially dissociated state in the solution. A film thickness of a graft polymer containing functional groups charged negatively in the solution increases approximately 100 times thicker than that in a dried condition because of electrostatic reaction and the like among the charged functional groups. Thus, the acrylic acid graft polymer is elongated in an alkali dispersion as shown in FIG. 1, and a particle having positive charge, i.e. a cationic particle adheres to the surface of the acrylic acid graft polymer. In this case, since a number of particles distributes in the vicinity of the surface, mutual electrostatic actions between the particles and functional groups in the graft polymer occur more easily than in a deep part. Accordingly, it is considered that more particles adhere to a side of free ends in the graft polymer (a site in the vicinity of the surface of the particle accumulation layer) as compared with a side of the fixed end (a site in the vicinity of the substrate). After allowing the substrate sufficiently to be in contact with the particle dispersion, the substrate is taken out, an extra dispersion is removed, and the substrate is washed, and dried. The elongated graft polymer shrinks due to drying, whereby a particle accumulation layer composed of accumulated multilayers of particles on the surface of the substrate is formed, so that it may be considered that a particle density in the vicinity of the surface is higher than that in the vicinity of a boundary of the substrate.

In the above-described example, the graft polymer contains functional groups charged negatively in a solution, and to which particles charged positively are allowed to adhere, however, the respective charges may be arbitrary. Even when a graft polymer contains functional groups charged positively in a solution, and particles having each surface charged negatively are allowed to react, the same effects can be obtained, as a matter of course.

The compounds useful for the formation of a hydrophilic graft polymer chain to be used in this invention preferably have a polymerizable double bond and hydrophilic properties. These compounds can be any of a hydrophilic polymer, a hydrophilic oligomer, and a hydrophilic monomer as long as it has a double bond in a molecule. The most useful compound of these is a hydrophilic monomer.

Examples of hydrophilic monomers useful in the present invention include positively charged monomers such as ammonium and phosphonium, and monomers which have an acid group such as a sulfonic acid group, a carboxyl group, a phosphoric acid group, or a phosphonic acid group, which are either negatively charged or can be dissociated with negative charge. Besides these, it is also possible to use hydrophilic monomers having a nonionic group such as a hydroxyl group, an amide group, a sulfonamide group, an alkoxy group, and a cyano group.

Specific examples of the hydrophilic monomer particularly useful in the present invention include the following monomers: (meta) acrylic acid or its alkali metal salt and amine salt; itaconic acid or its alkali metal salt and amine salt; allylamine or hydrogen halogenate acid salt; 3-vinyl propionic acid or its alkali metal salt and amine salt; vinyl sulfonic acid or its alkali metal salt and amine salt; styrene sulfonic acid or its alkali metal salt and amine salt; 2-sulfoethylene (meta) acrylate, 3-sulfopropylene (meta) acrylate or its alkali metal salt and amine salt; 2-acrylamide-2-methyl propane sulfonic acid or its alkali metal salt and amine salt; acid phosphoxy polyoxy ethylene glycol mono (meta) acrylate, or salts thereof; 2-dimethyl aminoethyl (meta) acrylate or its hydrogen halogenate acid salt; 3-trimethyl ammonium propyl (meta) acrylate, 3-trimethyl ammonium propyl (meta) acrylamide, or N,N,N-trimethyl-N-(2-hydroxy-3-methacryloyloxy propyl)ammonium chloride. It is also useful to use 2-hydroxyethyl (meta) acrylate, (meta) acrylamide, N-monomethylol (meta) acrylamide, N-dimethylol (meta) acrylamide; N-vinyl pyrrolidone, N-vinyl acetamide, and polyoxy ethylene glycol mono (meta) acrylate.

The film thickness of the surface provided on the substrate, where the graft polymer chain is present, can be selected depending on the application, however, in general, it is preferably in a range of 0.005 to 2.0 μm, and more preferably in a range of 0.01 to 1.0 μm, and most preferably in a range of 0.01 to 0.5 μm.

[Particles]

The following is a description about the particles forming the particle accumulation layer. There is no particular limitation on the types of the particles applicable to the present invention, and can be selected appropriately according to the intended function of the particle laminated substrate. The size of the particles can also be selected depending on the application however, from the properties of the particle accumulation layer, particles of nano meter or micron level are employed in general.

Examples of the material constituting the particles include organic polymer; natural or synthetic protein; inorganic material such as ceramic or metal; or their composite, and particularly preferable examples include inorganic particles such as semiconductor particle, TiO₂, or SiO₂; and polymeric particles such as polystyrene, polyacrylate, polyamide, polyurethane, or polyolefin. It is also possible to use particle such as synthetic or natural protein, liquid crystal micro capsule, particle whose phase can be changed by heat, hollow particles such as hollow silica, depending on the application of the thin film.

In general, the diameter of the particles is preferably in a range of 0.1 nm to 20 μm, more preferably in a range of 1 nm to 10 μm, and particularly preferably in a range of 5 nm to 5 μm. In an embodiment, the diameter of the particles is in a range of 1 nm to 200 nm.

Particles to be used may be properly selected in response to functions by intending to achieve by a particle accumulation layer. Furthermore, a particle diameter, an adhesion density and the like of a particle may be selected in response to purposes to be achieved. In the invention, particles act mutually with functional groups contained in a graft polymer to make adhesion one another in a dispersion. Accordingly, the particles may be the ones having physical properties in their surface which can act mutually with functional groups contained in the graft polymer, or the ones which are subjected to a surface treatment so that the above-described physical properties are obtained. As a surface treatment by which predetermined physical properties are achieved, for example, a manner for giving charges to particles used in the invention may be selected from well-known methods so far as desired functions of particles are attained.

Preferable examples of the particles usable in the particle accumulation layer of the present invention will be shown as follows however, the invention is not restricted to these examples. These functional particles will be explained in accordance with the functions to be provided to the particle accumulation layer on the surface.

(1-1) Particles for an Antireflection Member

When a particle accumulation layer of the invention is used for an antireflection function, it is preferable that at least one type of a particle selected from a resin particle and a metal oxide particle is used as the particle. The use of such particles realizes the usage of the particle laminated substrate as a roughened surface member which: has homogeneous and excellent antireflection capability preferably used for an image display surface; enables bright images without decreasing the image contrast; and has excellent durability which makes the surface suitable to the antireflection material.

The center part of a particle called “core” in the case of a resin particle is an organic polymer. Preferable examples of the metal oxide particle include silica (SiO₂), titanium oxide (TiO₂), zinc oxide (ZnO), tin oxide (SnO₂), and the like. It is also possible to use pigment particles so-called a transparent pigment or white pigment such as calcium carbonate, aluminum hydroxide, magnesium hydroxide, clay, or talc, as long as it has the preferable pattern described below. Furthermore, the shape of the particles can be selected depending on the application and hollow particles also can be used as well as spherical particles, for example, hollow silica and the like can be preferably used.

The resin particle has preferably a high degree of hardness in terms of durability. Specific examples thereof include a spherical particle made from resin such as acrylic resin, polystyrene resin, polyethylene resin, epoxy resin, or silicon resin. Above all, a cross-linked resin particle is particularly preferable.

When the particle laminated substrate of the present invention is used as the antireflection material, it is preferable, from the viewpoint of effects, to set the film thickness thereof to λ/4 with respect to the wavelength (λ) of which reflection should be prevented.

1-2. Particles for Conductive Film

When the particle accumulation layer of the present invention is used as a conductive film, it is preferable to use at least one type of particle selected from a conductive resin particle, a conductive or semiconductive metal particle, a metal oxide particle, and a metal compound particle, as the particle.

As a conductive metal particle or a metal oxide particle, conductive metal compound powder having a specific resistance value of no higher than 1×10³ Ω·cm can be used for various applications. To be more specific, it is possible to use silver (Ag), gold (Au), nickel (Ni), copper (Cu), aluminum (Al), tin (Sn), lead (Pb), zinc (Zn), iron (Fe), platinum (Pt), iridium (Ir), osmium (Os), palladium (Pd), rhodium (Rh), ruthenium (Ru), tungsten (W), molybdenum (Mo), alloys of these materials, tin oxide (SnO₂), indium oxide (In₂O³), ITO (Indium Tin Oxide), ruthenium oxide (RuO₂), or the like.

It is also possible to use metal oxides and metal compound particles having properties of semiconductor. Examples thereof include: oxide semiconductive particles such as In₂O₃, SnO₂, ZnO, Cdo, TiO₂, CdIn₂O₄, Cd₂SnO₂, Zn₂SnO₄, and In₂O₃-ZnO; particles doped with impurities suitable for these materials; spinel compound particles such as MgInO and CaGaO; conductive nitride particles such as TiN, ZrN, and HfN; and conductive boride particles such as LaB. These can be used either solely or as a mixture of two or more types.

1-3. Particles for Surface Antibacterial Material

When the particle accumulation layer of the present invention is used for an antibacterial function, it is preferable to use metals or metal oxide particles having antibacterial or sterilizing effects as the particle.

Specific examples of the materials which can form such metal (compound) particles include: metals as simple substance having sterilizing properties such as silver (Ag) and copper (Cu); alloys containing at least one type of these metals; and oxides of these metals. Examples thereof further include metal oxide semiconductors such as titanium oxide, iron oxide, tungsten oxide, zinc oxide, strontium titanate which exhibit sterilizing effects by the irradiation of light having the wavelength of ultraviolet region such as fluorescent lamp or sunshine; and metal compounds produced by modifying the above-described metal oxide compounds with platinum, gold, palladium, silver, copper, nickel, cobalt, rhodium, niobium, tin, and the like.

1-4. Particles for an Ultraviolet Adsorbing Member

When the particle laminated substrate of the present invention is used for an ultraviolet adsorbing function, it is preferable to use as the particle, a metal oxide particle such as iron oxide, titanium oxide, zinc oxide, cobalt oxide, chromium oxide, tin oxide, or antimony oxide in order to have a high light-blocking function in ultraviolet rays A and B regions (light wavelength of 280 to 400 nm). In an embodiment of the present invention, a polymer compound is used as the substrate and thus a particle accumulation layer in which ultraviolet-adsorbing particles are bonded to exhibit high function and processability as the ultraviolet blocking film sheet, thereby being expected to have various applications. In this embodiment, it is also expected to improve light stability against light, of the polymer material which is a substrate, by making use of the ultraviolet blocking effects of the metal oxide.

1-5. Particles for Optical Material

Examples of particles usable for the particle accumulation layer when the particle laminated substrate of the present invention is used in color filters, sharp cut filters, or nonlinear optical material for use in optical devices, include semiconductors such as CdS and CdSe and particles made from a metal such as gold. As the substrate, silica glass or alumina glass can be preferably used in color filters and the like. Further, as the high third-order optical nonlinear susceptibility thereof has been confirmed high recently, these materials are expected to function as nonlinear optical materials used for optical switches, optical memory, and the like. Specific examples of particles to be used in this case include noble metals such as gold, platinum, silver, and palladium and alloys thereof, and it is preferable in terms of safety to use particles made from material which is not quickly dissolved in alkali, such as gold or platinum.

Specific examples of the ultrafine particles of a metal (compound) suitable for using the particle laminated substrate of the invention as a nonlinear optical material include ultrafine particles with an average particle diameter of 10 to 1000 angstrom such as gold (Au), silver (Ag), copper (Cu), platinum (Pt), palladium (Pd), rhodium (Rh), osmium (Os), iron (Fe), nickel (Ni), and ruthenium (Ru) in simple substance, and alloys containing as least one type of these metals. Regarding the particle diameter, the particles may be either primary particle or secondary particle; however, it is preferable that the particles do not cause scattering of the visible light. Particularly preferable examples of the particles include noble metal particles which are selected from Au, Pt, Pd, Rh, and Ag, and metal particles selected from Ti, V, Cr, Mn, Fe, Ni, Cu, Zn, Cd, Y, W, Sn, Ge, In, and Ga which can be independently dispersed in a solvent such as toluene and have a particle diameter of not more than 10 nm.

1-7. Particles for Organic Electroluminescent Device

An organic electroluminescent device can be formed with the particle laminated substrate of the present invention by using particles containing aggregated organic dye molecules which emit light by the excitation of hot carriers as the particle, and forming a layer of such particles on the substrate surface having electrodes. Examples of the organic dyes which can be used in this case are mentioned below. However, the particles are not limited to such examples, and various types of organic dyes can be selected depending on the application of the solid photo-functional device.

Examples of the usable organic dyes include: oxazole-based dyes with blue light emission such as p-bis[2(5-phenyloxazole)]benzene (POPOP); coumarin-based dyes with green light emission such as coumarin 2, coumarin 6, coumarin 7, coumarin 24, coumarin 30, coumarin 102, and coumarin 540; rhodamine-based (red) dyes with red light emission such as rhodamine 6G rhodamine B, rhodamine 101, rhodamine 110, rhodamine 590, and rhodamine 640; oxazine-based dyes such as oxazine 1, oxazine 4, oxazine 9, and oxazine 118 which can provide light emission in the near-infrared region; and oxazine-based dyes which are particularly suitable for photo-functional devices matching with optical communication.

In addition, cyanine-based dyes such as phthalocyanine and a cyanine iodide compound can be used. In selecting these dyes, it is preferable to select those easily dissolved in a polymer like acrylic resin, in terms of forming a thin film. Such dyes include: POPOP, coumarin 2, coumarin 6, coumarin 30, rhodamine 6G, rhodamine B, and rhodamine 101.

Examples of the above-described particles to be used further include organic molecules used for an organic electroluminescence (EL) film such as 8-hydroxy quinoline aluminum (Alq₃), 1,4-bis-2,2 diphenyl vinyl)biphenyl, a polyparaphenylene vinylene (PPV) derivative, a distyryl arylene derivative, a styryl biphenyl derivative, a phenanthroline derivative, or particles made from a solvent composed of the organic molecules and an additive.

(Substrate)

The substrate used to form the surface where a graft polymer chain having a polar group is present, of the present invention, can be of any material, as long as it has an excellent dimensional stability and meets the required levels of flexibility, strength, durability, and the like. A plate-like material is generally used, however, it may be a molded component which has been molded into a shape depending on its application.

However, when a transparent substrate requiring light transmission properties is selected, it is possible to use transparent inorganic substrate such as glass, plastic film (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal), ITO. As the substrate not requiring transparency, it is possible to use, in addition to those mentioned above, paper, paper laminated with plastic, plates of metal (for example, aluminum, zinc, and copper), paper or plastic films laminated or vapor deposited with the metals which mentioned above, an inorganic substrate as represented by silicon.

These materials can be appropriately selected according to the application and the relation with the particle to be adsorbed, and in terms of processability and transparency, the substrate having a surface made from a polymer resin is preferable. To be more specific, resin film, transparent inorganic substrate such as glass whose surface is coated with resin, a composite material whose surface layer is a resin layer can all be used preferably.

The typical examples of the substrate having a surface coated with resin include: a laminate plate with a surface having a resin film pasted thereon; a substrate subjected to a primer process; and a substrate subjected to a hard coat process. The typical examples of the composite material having a resin layer as the surface layer include a resin seal member having an adhesive agent layer on its back surface side, and a laminated glass consisting of glass and resin.

As long as the support has excellent flatness, any material is preferable as the support used for particle accumulation.

[Preparation of the Particle-Containing Liquid]

The particle-containing liquid can be prepared by dispersing the aforementioned functional particles in a water-based solvent. The amount of the particles to be added is preferably in a range of 0.1 to 50% by mass, and more preferably in a range of 0.5 to 20% by mass. Too large or too small content of particles makes it difficult to produce uniform accumulation.

The dispersion medium is preferably a water-based solvent in terms of the affinity with a hydrophilic surface, and to be more specific, it is possible to use water; alcohols such as methanol and ethanol; and ethers such as THF, dioxane, ethylene glycol, and dimethyl ether.

[Immersion]

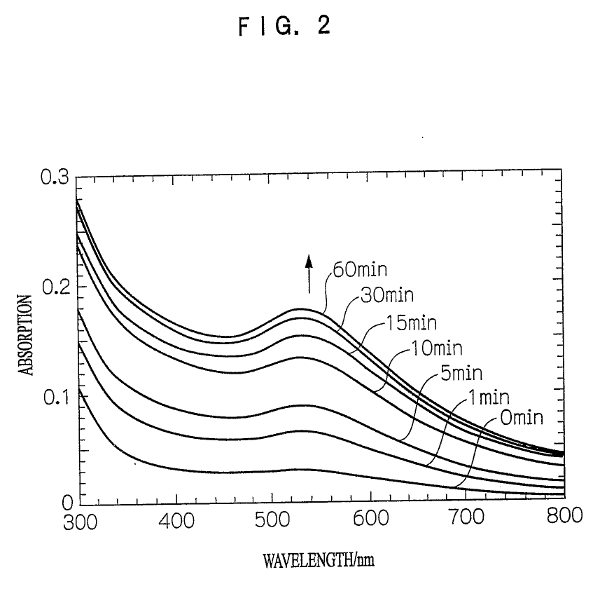

A substrate having a graft polymer is immersed in the particle-containing liquid prepared as described above for a predetermined time, thereafter, the substrate is taken out, an extra liquid is removed, the substrate is washed, and dried, whereby a particle laminated substrate of the invention can be obtained. FIG. 2 shows an absorption spectrum of a particle laminated layer substrate which is prepared by such a manner that the gold particles described in the above specific example are allowed to adhere to a polyacrylic acid graft, and are accumulated. The absorption maximum is 530 nm, which is a longer wavelength of only about 10 nm as compared with a value in a solution, while the absorption maximum is substantially the same as that described above in a sample an immersion time of which is prolonged for 60 minutes. A measurement of absorption spectrum is made using an UV-vis spectrophotometer (trade name: U-2010 manufactured by Hitachi, Ltd.)

[Drying]

Since uneven agglomeration of particles may occur in case rapidly drying a substrate, a drying temperature is preferably 180° C. or less in general although it depends on a solvent to be used. More preferably a drying temperature is in the range of room temperature to 80° C. Particularly, it is preferred to gradually dry the substrate approximately at room temperature with taking a considerable time to form a uniform particle accumulation layer.

A preferable drying time is in the range of 10 seconds to 10 hours, and more preferably 1 minute to 6 hours. In case of using water as a dispersion medium, approximately 3 to 6 hours are preferred.

Although an average thickness of a particle accumulation layer to be formed may be properly selected depending on the application, it is preferable in the range of 10 nm to 2000 nm as mentioned previously to develop functional effects in functional particles. In the invention, thickness measured from a sectional TEM photograph is adopted for a thickness of the particle accumulation layer.

Since the particle laminated substrate thus obtained has a particle accumulation layer, wherein arbitrary particles distribute in its surface at a high density while they distribute in its deep portion at a comparatively low density, on a surface of the substrate, arbitrary functions can be easily applied on the surface of a thin film. Furthermore, since particles distribute unevenly so as to be high density in the surface of the particle accumulation layer, it contributes efficiently to surface characteristic properties relative to an amount of adhesion, so that its applicable range is wide.

A condition wherein a particle accumulation layer in which particles are distributed at a high density on its surface is formed on a substrate can be easily confirmed, for example, by observing a sectional area with a transmission electron microscope.

The disclosure of Japanese Patent Application No. 2004-319288 is incorporated by reference herein.

### EXAMPLES

In the following, the invention is specifically described with reference to examples, but it is to be noted that the invention is not limited thereto.

### Example 1

### Preparation of Substrate Having Graft Polymer on Surface Thereof

(Synthesis of Silane Terminal Initiator SiP: Phenyl-[1-(11-trichlorosilanyl-undesiloxy)-cyclohexyl]-methanone)

Nitrogen was flowed through a calcium chloride tube fitted to a 1000 ml three-necked flask. 28.6 g (0.14 mol) of 1-hydroxycyclohexylphenylketone were dissolved in a mixed solvent of 60 g of dimethylacetamide (DMAc) dehydrated with a molecular sieve in the flask and 60 g of tetrahydrofuran (THF) dehydrated as described above, and 8.4 g (0.21 mol) of sodium hydride (NaH) (60 to 72% in oil) were gradually added to the resulting solution in an ice bath. To the solution, 51.6 g (0.21 mol) of 11-bromo-1-undecene (95%) was dropped to react with them at room temperature. As a result of a reaction trace with TLC, the reaction was completed for one hour.

The reaction solution was introduced in ice water, extracted with ethyl acetate, and concentrated. Then, 74.2 g of the resulting mixture were picked up, dissolved in 740 ml of acetonitrile, and 14.8 g of water were added thereto. To the resulting mixture, 3.7 g of p-toluenesulfonic acid monohydrate was added, and agitated at room temperature for one hour. An organic phase was extracted with ethyl acetate, and a solvent was evaporated to distill off the same. A terminal double bond initiator (SiP-a) was isolated using a column chromatography (a filler: Wakogel C-2000, a developing solvent: ethyl acetate/hexane=1/90). NMR (trade name: AV400 (400.13 MHz), manufactured by BRUKER) and IR (trade name: Excalibur FTS3000MX, manufactured by DIGILAB) were used.

¹H NHR (CDCl₃)

d=1.23 to 1.80 (m, 24H), 2.00 to 2.06 (td, J=7.3, 7.1 Hz, 2H), 3.19 to 3.22 (t, J=6.6 Hz, 2H), 4.91 to 4.95 (ddt, J=10.1, 2.1, 1.1 Hz, 1H), 4.96 to 5.02 (ddt, J=17.2, 1.6, 1.8 Hz, 1H), 5.76 to 5.86 (ddt, J=1.70, 10.2, 6.7 Hz, 1H), 7.39 to 7.43 (td, J=6.8, 1.3 Hz, 2H), 7.49 to 7.54 (tt, J=7.4, 1.4 Hz, 1H), 8.26 to 8.28 (d, 2H)

IR (KBr): 1677 (s), 1245 (m), 1082 (s) cm⁻¹

To a 50 ml three-necked flask, a calcium chloride tube and a cooling tube were fitted. In the flask, one drop of Speir catalyst (H₂PtCl₄·6H₂O/2-PrOH 0.1 M) was added to 2.3 g (0.0065 mol) of the terminal double bond initiator (SiP-a) obtained as described above, 1.3 g (0.0098 mol) of trichlorosilane was dropped in an ice bath, agitated, and returned to room temperature. After 3 hours, the reaction was completed. After completing the reaction, unreacted trichlorosilane was distilled away by heating to 50° C. under a reduced pressure. As a residue after trichlorosilane was distilled away, a brown oil-like terminal silane coupling initiator (Sip: the structure represented as above) was obtained.

¹H NMR (CDCl₃)

d=1.23 to 1.79 (m, 30H), 3.19 to 3.23 (t, J=6.6 Hz, 2H), 7.36 to 7.43 (t, J=7.6 Hz, 2H), 7.50 to 7.54 (t, J=7.2 Hz, 1H), 8.26 to 8.28 (d, 2H)

IR (KBr): 1678 (s), 1246 (m), 1082 (m) cm⁻¹

(Production of Graft Polymer)

A surface of silicon substrate (one side polished 4 inch wafer for semiconductor use (trade name: 4-FY, manufactured by SUMCO Corporation, crystal orientation <1-0-0>) was washed, immersed in 1% by mass concentration of toluene solution of the silane terminal initiator (SiP) obtained in the above-described synthetic example at room temperature for 10 minutes, taken out, and washed sufficiently with toluene, whereby a substrate on the surface of which the initiator had been immobilized was obtained.

The resulting substrate on which the initiator was immobilized was immersed in 10% by mass of an aqueous solution of acrylic acid, and ultraviolet irradiation was exposed for 5 minutes using an ultraviolet exposure apparatus (trade name: UVX02516S1LP01, 1.5 kW, manufactured by Ushio Inc.), whereby an acrylic acid graft polymer starting from the initiator was produced. After exposing to ultraviolet irradiation, the substrate was taken out, washed repeatedly with water, further washed with sodium bicarbonate water (5% by mass), and a substrate on the surface of which graft polymer chains are distributed was obtained.

(Synthesis of quaternary ammonium protective agent (TMC))

Three hundred ml three-necked flask fitted with a calcium chloride tube was charged with 40.4 g (0.156 mol) of 11-bromoundecanoic acid, and dissolved in 100 ml of dimethylacetamide (DMAc) in an ice bath. To the resulting solution, 15.8 g (0.156 mol) of triethylamine was dropped; succeedingly 16.9 g (0.156 mol) of ethyl chloroformate dissolved in 50 ml of DMAc was dropped, and agitated for one hour. To the resulting reaction solution, 17.6 g (0.078 mol) of ground cystamine dihydrochloride was added, and 15.8 g (0.156 mol) of triethylamine was dropped again. The reaction solution was introduced in 4000 ml of 23 wt % of brine solution, and agitated. As a result, a white precipitation was separated out. After allowing the resulting mixture to stand, a supernatant liquid was removed, filtrated further, and the precipitation was washed with water. The precipitation was recrystallized twice with ethyl acetate to obtain a white solid and an yield thereof was 30%.

Then, a 1000 ml three-necked flask fitted with a cooling tube and calcium chloride tube was charged with 17.0 g (26.4×10⁻³ mol) of the white solid, 650 ml of THF was added thereto, heated and dissolved, and then the temperature was returned to room temperature. The cooling tube and the calcium chloride tube were removed from the flask, and trimethylamine gas was bubbled in the reaction solution. To an outlet for gas, two of hydrochloric acid traps were linked. Trimethylamine gas was flowed individually into the flask six times for five hours, and reaction-traced with TLC. The reaction solution became clouded to produce a colorless clear precipitation. The reaction solution was reprecipitated together with the precipitation to obtain a white solid-like target (TMC: the structure is represented as described above), and an yield of which was 80%.

(Adjustment of Gold Particles Protected by Quaternary Ammonium Protective Agent (TMC))

A 1000 ml three-necked flask was charged with 0.49 g (1.2×10⁻³ mol) of tetrachloroaurate (III) tetrahydrate to dissolve into 200 ml of water. To which, 0.44 g (0.6×10⁻³ mol) of TMC dissolved into 40 ml of water was added and agitated. While agitating the reaction solution, when 1.47 g (40.0×10⁻³ mol) of sodium boron hydride dissolved in 100 ml of water were slowly dropped in the reaction solution, it bubbled vigorously to turn into a violet solution. The reaction solution was slowly introduced in 3000 ml of acetone which was agitated. Agitation was continued for two or more hours, whereby a violet precipitation was produced. The mixture was filtrated with a microfilter to obtain black powder-like gold particles. The gold particles were well dispersed into water. An average particle diameter of the gold particles determined from measurement of TEM was about 5 nm, and the particle sizes were distributed from a comparatively small particle diameter of about 1 nm to a large particle diameter of about 7 nm.

(Adhesion of Gold Particle to Graft Polymer)

A silicon substrate having acrylic acid graft polymer chains obtained as described above was immersed in a water dispersion of gold particles (pH=8.9). Thereafter, the substrate was taken out, washed with a sufficient amount of water, allowed to stand at room temperature for one hour to be dried, and hence, a particle laminated substrate was obtained.

For the sake of examining a relationship between an immersing time and a film thickness of the resulting particle accumulation layer, tests were implemented before immersion (0 minute), immersion times: one minute, five minutes, ten minutes, fifteen minutes, thirty minutes, and sixty minutes.

(Measurement of Film Thickness in Particle Accumulation Layer)

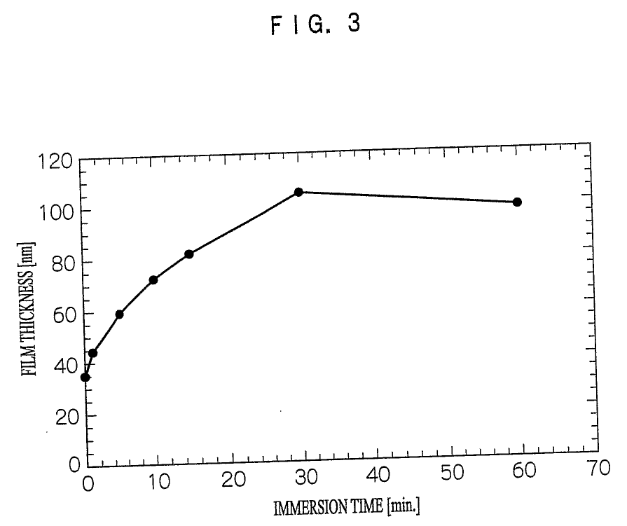

Film thicknesses in particle accumulation layers of particle laminated substrates obtained by changing the immersion time were measured directly by an ellipsometry (trade name: VASE, manufactured by J. A. Woollam Co., Inc.). FIG. 3 shows a graph showing a relationship between an immersion time and a film thickness of particle accumulation layer which was measured directly by means of an ellipsometry. According to the graph, it is found that a film thickness of the particle accumulation layer increases with an increase in the immersion time. For instance, when the particle accumulation layer was immersed for 30 minutes, a film thickness of the particle accumulation layer increased from a film thickness of the particle accumulation layer in an initial surface graft polymer of about 30 nm to about 100 nm.

(Confirmation of Section of Particle Laminated Substrate)

A TEM observation of a section in the particle laminated substrate was made as follows. First, a sample was cut out into an about 5 mm square, and the sample was carbon-deposited with a thickness of about 15 nm. Then platinum was deposited on the sample with a thickness of about 50 nm, and further carbon was allowed to adhere to a surface of a processing site to a thickness of about 1.5 μm in an FIB apparatus. Thereafter, an ultrathin segment with a thickness of 100 nm was fabricated by the FIB (trade name: FB-2100, manufactured by Hitachi Ltd.) wherein an acceleration voltage was 200 kV.

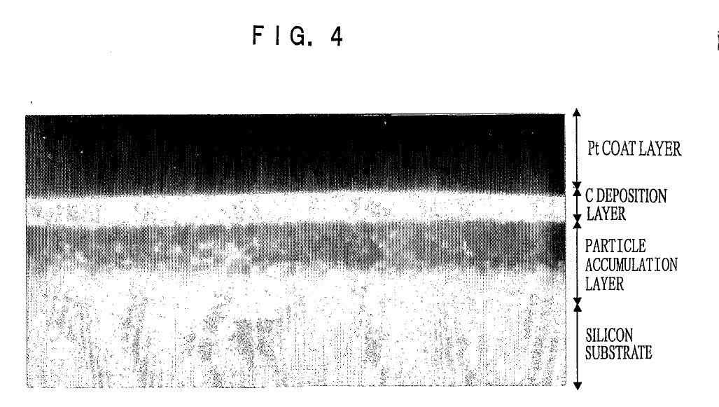

FIG. 4 is a sectional TEM photograph showing a particle laminated substrate obtained in example 1 wherein gold particles adhere to a surface of the substrate. In the photograph, a particle accumulation layer wherein particles adhering to a graft polymer on the silicon substrate is observed, whereby it was found that particles having an average particle diameter of about 5 nm were accumulated in multilayers inside the surface graft polymer. It was further confirmed that a distribution of the gold particles was not uniform inside the accumulated layer, and they were distributed in the surface at a higher density.

(Existence of Particles in Particle Accumulation Layer)

For the purpose of confirming a distribution of gold particles inside the layer, a glow discharge spectrometry (GDS) measurement was made.

The GDS method is a manner wherein a surface of a sample is sputtered with argon glow to chip off the surface, and fluorescence of elements discharged at that time is detected, whereby compositions of the elements existing on the surface are analyzed. Since sputtering proceeds in the depth direction with elapse of time, an elemental analysis of a film composition in the depth direction can be made.

The glow discharge spectrometry (GDS) (trade name: Rigaku/Spectrum GDA 750, manufactured by Rigaku Corporation) was used wherein measuring conditions were RF Power 20W, 13.56 MHz, and Ar Gas 2.0 hPa.

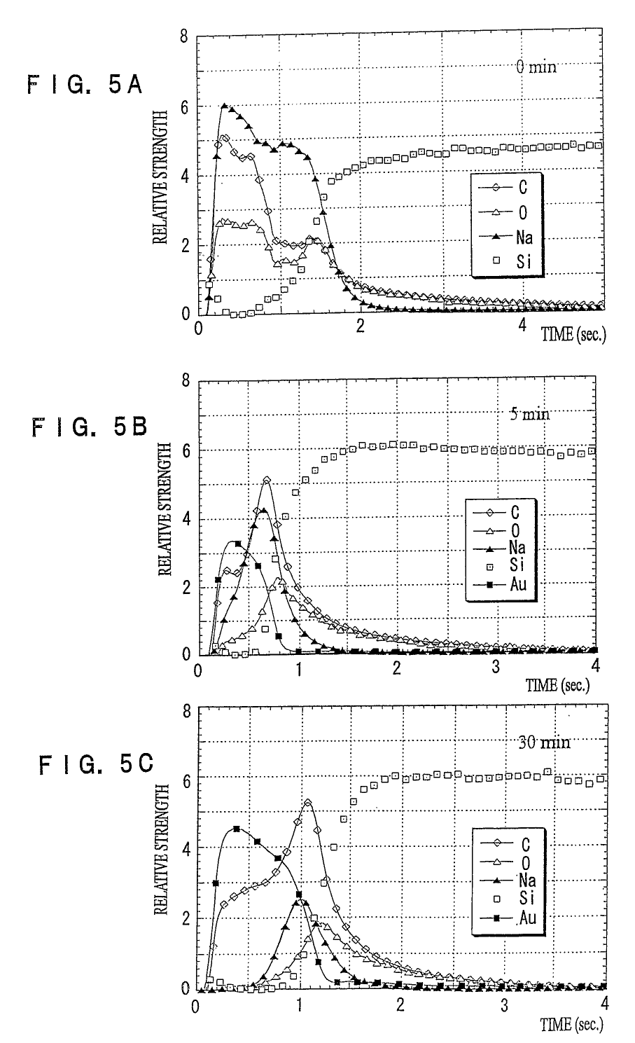

FIGS. 5A, 5B, and 5C are graphs each indicating measured results of glow discharge spectrometry (GDS) wherein FIG. 5A is a graph indicating measured results of glow discharge spectrometry (GDS) of a substrate having a surface in which graft polymers to which particles have not yet adhere distribute, FIG. 5B is a graph indicating measured results of glow discharge spectrometry (GDS) of a substrate having a particle accumulation layer formed by immersing the substrate into a gold particle dispersion for five minutes, and FIG. 5C is a graph indicating measured results of glow discharge spectrometry (GDS) of a substrate having a particle accumulation layer formed by immersing the substrate into a gold particle dispersion for thirty minutes. As is apparent from FIG. 5A, the surface of graft polymer layer prior to immersing the gold particle dispersion indicates in the initial period of a sputtering time that carbon, oxygen, hydrogen, and sodium being constituent elements of the surface graft polymer exist. The sodium is derived from a functional group of sodium carboxylate in the surface graft polymer. With the elapse of a sputtering time, strength of silicon derived from the silicon substrate appears remarkably. In the particle accumulation layer formed by immersing the substrate into the gold particle dispersion for five minutes, a strength of gold increases, while strength of sodium decreases. This means that since the substrate is immersed in a dispersion of gold nanoparticles, sodium of the sodium carboxylate is replaced by nanoparticles charged positively. Such tendency becomes remarkable in the sample which was immersed in the gold particle dispersion for 30 minutes as is apparent from FIG. 5C. In both the GDS spectra of the particle laminated substrates shown in FIGS. 5B and 5C, it is apparent that gold particles are distributed in the vicinity of a surface of the layer in the particle accumulation layer, while sodium indicating existence of the graft polymer is distributed inside the particle accumulation layer, namely, in the vicinity of a boundary face of the substrate. These results coincide with those observed in the TEM photograph (FIG. 4). Namely, it has been confirmed that although particles are accumulated in multilayers in a particle accumulation layer of the particle laminated substrate of the invention, its distribution is not uniform, but the particles are distributed in the vicinity of the surface at a high density.

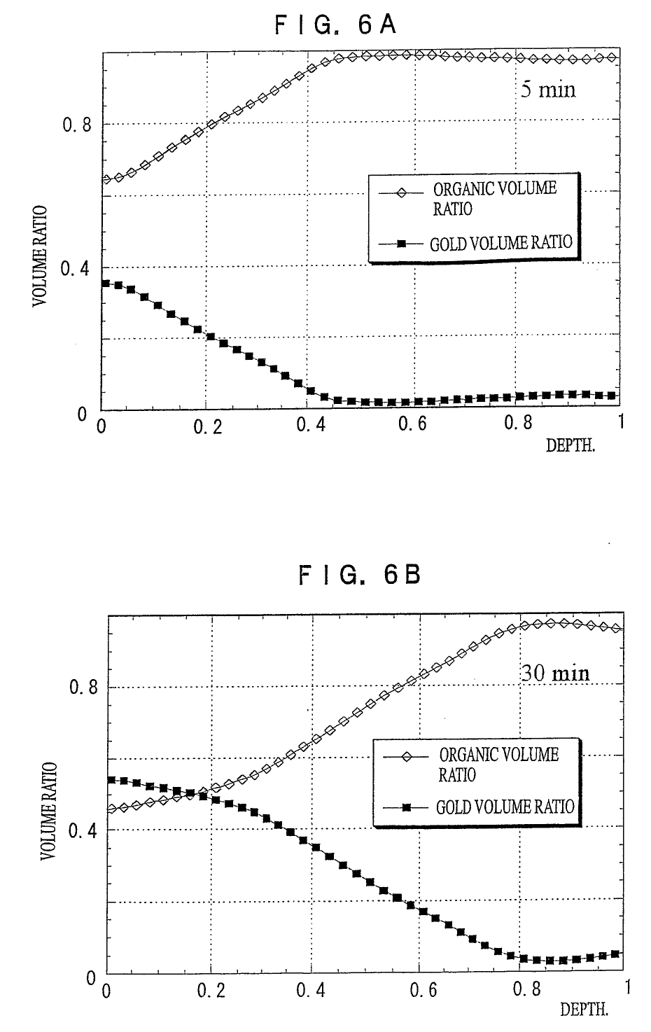

Next, a method for measuring a volume ratio of particles in a particle accumulation layer from the above-described GDS results measured and the results obtained therefrom will be mentioned. First, a ratio of elements in constituent atoms in a depth direction of a film thickness of the particle accumulation layer is determined with the elapse of a sputtering time in the above-described GDS method. Then, ratios of elements of all the constituent atoms except for Si being the constituent element of the substrate are determined. Among those elements, only C and O derived from organic components, and Na (derived from —COONa being a functional group of acrylic acid graft polymer) as well as Au element being a constituent component of particles are noticed. Volume ratios of organic components (a polymer+a surface layer of gold particles) and the gold component in the depth direction are determined in such a manner that weight rates calculated from the previously determined ratios of the elements are converted into volume ratios wherein a specific gravity of the organic components is considered to be 1.5 and that of gold to be 19.3. The results obtained by applying the above-described manner to the particle accumulation layer prepared by the 5 minutes immersion time, and the particle accumulation layer prepared by the 30 minutes immersion time are shown in FIGS. 6A and 6B, respectively. The graphs indicate volume ratios of the organic components and the gold component in their depth directions (indicated by abscissa axis), and it has been found that gold particles are distributed unevenly so as to be at a high density in the surface in both the cases. Moreover, it has been confirmed in comparison of FIG. 6A with FIG. 6B that when an immersion time is prolonged, gold particles distribute into a deeper site of the particle accumulation layer.

Based on the results as mentioned above, it has been confirmed that particles are distributed unevenly so as to be at high density in the surface of a particle accumulation layer, and a particle density in the vicinity of the surface is higher than that in the vicinity of the substrate in the particle laminated substrate of the invention from the any of the results as to ratios of the constituent elements, and volume ratios of the particles. Accordingly, the particle laminated substrate of the invention is expected to be a material which contain functional particles distributed unevenly so as to be at a high density in the surface of the a particle accumulation layer, so that functions of a higher degree can be developed relative to an actual amount of adhesion. Thus, an applicable range of the particle laminated substrate of the invention is considerably broad.

The invention has advantageous effects in that a particle laminated substrate having a high-quality particle accumulation layer formed on a surface of the substrate such that functional particles are distributed unevenly at a high density in the vicinity of the surface can be obtained. Further, according to the manufacturing method of the invention, a particle laminated substrate having a particle accumulation layer wherein functional particles are distributed at a high density in the vicinity of the surface of the particle accumulation layer can be easily formed by controlling the accumulation of particles through simple steps.

1. A particle laminated substrate comprising a particle accumulation layer formed by accumulating and allowing particles to adhere onto a substrate having a surface where a graft polymer chain is present wherein either terminal of the polymer is bonded to the surface of the substrate, by means of an electrostatic accumulating phenomenon, wherein a particle density in the vicinity of the surface of the particle accumulation layer is higher than a particle density in the vicinity of the substrate.

2. The particle laminated substrate of claim 1, wherein an average thickness of the particle accumulation layer measured by a sectional TEM photograph ranges from 10 nm to 2000 nm.

3. The particle laminated substrate of claim 1, wherein, in the particle accumulation layer, a particle content in the outermost surface is 30% by volume or more, and a particle content in a boundary face to the substrate is 10% by volume or less.

4. The particle laminated substrate of claim 1, wherein a particle diameter of the particles ranges from 1 nm to 200 nm.

5. A method for manufacturing a particle laminated substrate, comprising:
allowing a surface of the substrate where a graft polymer chain, which has a functional group which is chargeable positively or negatively and whose either terminal is bonded to the surface of the substrate, is present to be in contact with a liquid containing particles each of which have a surface charged to a charge inverse to that of the charged functional group, thereby causing the graft polymer to swell and expand in the liquid;
allowing the particles whose surfaces are charged to a charge inverse to that of the functional group to adhere to the functional group of the graft polymer charged positively or negatively in the liquid by means of an electrostatic accumulating phenomenon; and thereafter,
removing the liquid and drying to form a particle accumulation layer, wherein a particle density in the vicinity of the surface of the particle accumulation layer is higher than a particle density in the vicinity of the substrate.

6. The method for manufacturing a particle laminated substrate of claim 5, wherein an average thickness of the particle accumulation layer measured by a sectional TEM photograph ranges from 10 nm to 2000 nm.

7. The method for manufacturing a particle laminated substrate of claim 5, wherein in the particle accumulation layer, a particle content in the outermost surface is 30% by volume or more, and a particle content in a boundary face to the substrate is 10% by volume or less.

8. The method for manufacturing a particle laminated substrate of claim 5, wherein a particle diameter of the particles ranges from 1 nm to 200 nm.
